(19) United States
(12) Patent Application Publication
(10) Pub. No.: US 2001/0049563 A1
(43) Pub. Date: Dec. 6, 2001

(54) Irrigation management system

(75) Inventors: John Addink, Riverside, CA (US); Sylvan Addink, Iowa City, IA (US)

Correspondence Address: Robert D. Fish, Suite 706, 1440 N. Harbor Blvd., Fullerton, CA, 92835, US

(73) Assignee: Aqua Conservation Systems, Inc.

(21) Appl. No.: 09/852,230

(22) Filed: May 8, 2001

Related U.S. Application Data
(60) Provisional application No. 60/209,709, filed on Jun. 5, 2000.

(51) Int. Cl. G05B 11/01; G05D 7/00; G05D 11/00

(52) U.S. Cl. 700/19; 700/284

(57) ABSTRACT

An irrigation management system comprises a microprocessor that determines a mathematical relationship between a calculated watering requirement and an applied irrigation amount; and an output device that provides a result of the mathematical relationship to at least one of an irrigation user and a third party. Preferably the calculated watering requirement is at least partly derived from ETo data. Additionally, the calculated watering requirement is at least partly derived from a crop coefficient value and an irrigation efficiency value. Preferably the applied irrigation amount is derived from data obtained from a flow meter and preferably from a utility meter that was initially installed at the irrigation site. Water pressure can also be measured and communicated to the irrigation user and/or third party.

This application claims priority to U.S. patent application Ser. No. 60/209709 filed on Jun. 5, 2000.

### FIELD OF THE INVENTION

The field of the invention is irrigation management systems.

### BACKGROUND OF THE INVENTION

In arid areas of the world water is becoming one of the most precious natural resources. Meeting future water needs in these arid areas may require aggressive conservation measures, including efficient irrigation management systems. Efficient irrigation management systems involve the irrigation of plants based on a plants' actual water requirements. Most of the irrigation systems today do not irrigate the landscape based on the actual water requirements of the plants.

The majority of irrigation systems use manual inputs of irrigation schedules. In using such controllers an irrigation user typically sets a watering schedule that involves specific run times and days for each of a plurality of stations, and the controller executes the same schedule regardless of the season or weather conditions. From time to time the user may manually adjust the watering schedule, but such adjustments are usually only made a few times during the year, and are based upon the irrigation user's perceptions rather than the landscapes actual watering needs. One change is often made in the late Spring when a portion of the landscape becomes brown due to a lack of water. Another change is often made in the late Fall when the irrigation user assumes that the vegetation does not require as much watering. These changes to the watering schedule are typically insufficient to achieve efficient watering. Furthermore, the irrigation user will likely not change their irrigation practices until they are made aware of how inefficient their watering practices are.

Irrigation of plants based upon actual water requirements requires knowing when the moisture level in the soil is below an amount that is required for good plant growth. Soil moisture sensors are used by some irrigation systems to monitor the moisture in the soil. However, such systems are limited, especially in agricultural situations, in that soil moisture sensors tend to be costly and only monitor soil conditions immediately adjacent to the sensor.

A plant's water requirements can also be determined by calculating the quantity of water that is removed from the soil by evapotranspiration. Evapotranspiration is the water lost by direct evaporation from the soil and plant, as well as by transpiration from the plant surface. Replacement of the water removed by potential evapotranspiration (ETo) generally meets the water requirements of the plants.

Irrigation controllers that derive all or part of the irrigation schedule from ETo data (ET irrigation controllers) are discussed in U.S. Pat. No. 5,479,339 issued December 1995, to Miller, U.S. Pat. No. 5,097,861 issued March 1992 to Hopkins, et al., U.S. Pat. No. 5,023,787 issued June 1991 and U.S. Pat. No. 5,229,937 issued July 1993 both to Evelyn-Veere, U.S. Pat. No. 5,208,855, issued May 1993, to Marian, U.S. Pat. No. 5,696,671, issued December 1997, and U.S. Pat. No. 5,870,302, issued February 1999, both to Oliver and U.S. Pat. No. 6,102,061, issued August, 2000 to Addink. Although, the watering practices of irrigation users with ET irrigation controllers are generally far more efficient than irrigation controllers with manual inputs, the irrigation efficiency of most of these ET irrigation systems can also be improved.

Currently, some operators with manually operated agricultural irrigation systems try to efficiently irrigate their fields based on ETo data. With manually operated agricultural irrigation systems, the operator obtains ETo data and based on the listed water application rates from the manufacturer the operator tries, with timely irrigation, to replace the water lost due to evapotranspiration. However, in most cases they do not receive adequate feedback on the actual quantity of water that was applied to specific fields, and therefore they do not know if they are actually replacing the moisture lost due to evapotranspiration. Moisture sensors can be used to help circumvent this problem, but as mentioned above there are inherent problems in the use of soil moisture sensors in the scheduling of irrigation applications.

Flow meters are used with some irrigation systems and are discussed in U.S. Pat. No. 4,209,131 issued June 1980, to Barash, U.S. Pat. No. 5,176,163 issued January 1993, to Al-Hamlan, U.S. Pat. No. 5,971,011 issued October 1999, to Price and U.S. Pat. Nos. 5,097,861, 5,229,937, and 6,102,061 mentioned above. Irrigation systems discussed in U.S. Pat. Nos. 4,209,131, 5,176,163, 5,229,937, and 6,102,061 use the flow meter primarily to set limits to the quantity of water that will be applied by the irrigation system. In U.S. Pat. Nos. 5,097,861 and 5,971,011 the flow meters are primarily used for leak detection. As indicated above, known flow meters, used with irrigation systems, are mainly used for specific purposes and not to provide feedback to the irrigation user on the actual amount of water applied in relationship to the water required by the plant.

Thus, there is still a need for an irrigation management system that utilizes ETo data, flow data, pressure data, sensors, feedback communication systems, and so forth, manipulates that data to estimate how efficiently the system is irrigating the landscape, and further provides that information to both the irrigation user and a third party, so that the third party can monitor and possibly assist in attaining greater irrigation efficiency.

### SUMMARY OF THE INVENTION

An irrigation management system comprising: a microprocessor that (a) determines a calculated watering requirement and an applied irrigation amount for a time period for an area of an irrigated site, and (b) determines a mathematical relationship between the calculated watering requirement and the applied irrigation amount; and an output device that provides a result of the mathematical relationship to at least one of an irrigation user and a third party.

The microprocessor is preferably disposed in an irrigation controller. Alternatively, the microprocessor may be disposed in a personal computer or some other suitable device involved in the control of the irrigation system.

In a preferred embodiment the calculated watering requirement is at least partly derived from ETo data. The ETo data may be potential ETo data, estimated ETo data or historical ETo data. Furthermore, the ETo data may be received from a device local to the irrigation site or distal to the irrigation site. Additionally, the calculated watering requirement is at least partly derived from a crop coefficient value and an irrigation efficiency value.

The applied irrigation amount is preferably derived from data obtained from a flow meter. Alternatively, the applied irrigation amount is derived from data obtained from an irrigation water collector or other device that can accurately measure or estimate the applied irrigation amount.

If the applied irrigation amount is derived from flow data, the flow data may advantageously be obtained from a utility meter that was initially installed at the irrigation site. Alternatively, the flow data may be from a flow meter separate from the utility meter installed at the irrigation site. The flow data may be raw data or processed data.

The time period for determining the calculated watering requirement and the applied irrigation amount is at least 10 seconds.

The irrigated site may be a residential site, commercial site, agricultural site, horticultural site or any other irrigated site.

The output device may be a display screen, printed material, an audible device such as a telephone, or any other type of output device that effectively communicates the result to the irrigation user and/or a third party.

The result may be a ratio of the calculated watering requirement to the applied irrigation amount. Alternatively, the result may be the difference between the calculated watering requirement and the applied irrigation amount or any other suitable mathematical determination to indicate the relationship between the calculated watering requirement and the applied irrigation amount.

In a preferred embodiment of the present invention, water pressure is also measured and communicated to the irrigation user and/or third party.

Various objects, features, aspects, and advantages of the present invention will become more apparent from the following detailed description that describes a preferred embodiment of the invention, along with the accompanying drawings in which like numerals represent like components.

### BRIEF DESCRIPTION OF THE DRAWINGS

FIG. 1 is a schematic of an irrigation controller according to an aspect of the present invention.

FIG. 2 is a block diagram of an irrigation system according to an aspect of the present invention.

FIG. 3 is a flow chart of steps involved in a preferred embodiment of the present invention.

FIG. 4 is a graph representing calculated watering requirements based upon historical ETo data and applied irrigation amounts for a twelve month period.

### DETAILED DESCRIPTION

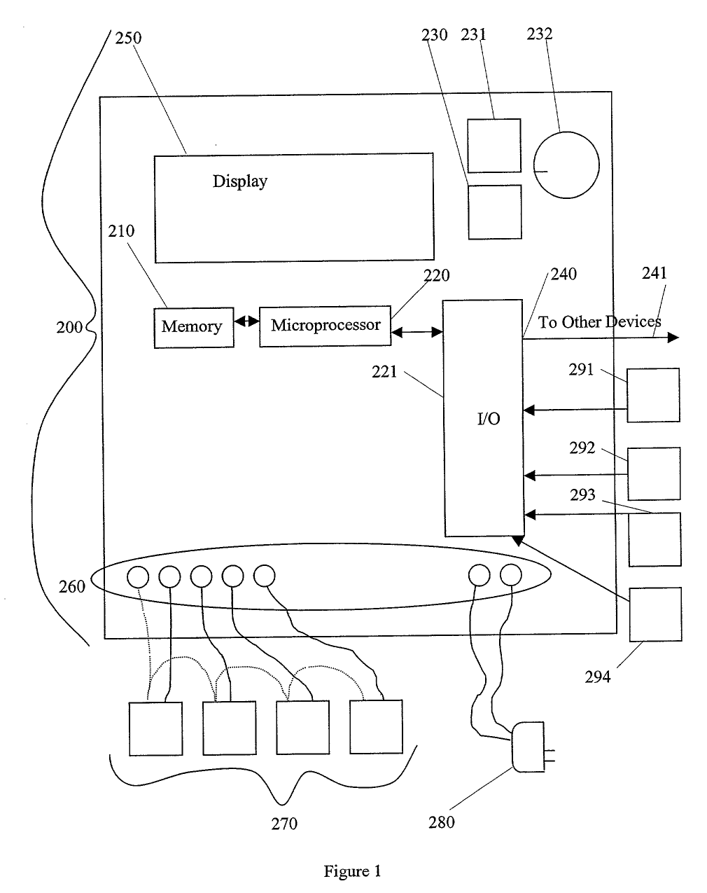

FIG. 1 is a schematic of an irrigation controller 200 according to an aspect of the present invention that generally includes a microprocessor 220, an on-board memory 210, some manual input devices 230 through 232 (buttons and/or knobs), an input/output (I/O) circuitry 221 connected in a conventional manner, a display screen 250, a communications port 240, a serial, parallel or other communications connection 241 coupling the irrigation controller to other devices, such as personal computers, telephone lines, etc., electrical connectors 260 which are connected to a plurality of irrigation stations 270 and a power supply 280, a rain detection device 291, a flow sensor 292, a pressure sensor 293 and a temperature sensor 294. Each of these components by itself is well known in the electronic industry, with the exception of the programming of the microprocessor in accordance with the functionality set forth herein. There are hundreds of suitable chips that can be used for this purpose. At present, experimental versions have been made using a generic Intel 80C54 chip, and it is contemplated that such a chip would be satisfactory for production models.

In a preferred embodiment of the present invention the controller has one or more common communication internal bus(es). The bus can use a common or custom protocol to communicate between devices. There are several suitable communication protocols, which can be used for this purpose. At present, experimental versions have been made using an I²C serial data communication, and it is contemplated that this communication method would be satisfactory for production models. This bus is used for internal data transfer to and from the EEPROM memory, and is used for communication with peripheral devices and measurement equipment including but not limited to water flow sensors, water pressure sensors, and temperature sensors.

Automatic irrigation controllers are primarily used with irrigation systems that water landscapes at residential, commercial, golf course, and public sites. However, many irrigation systems used in agricultural, fruit and vegetable production are still manually controlled. Therefore, with these irrigation systems the microprocessor may advantageously be disposed in a personal computer or alternatively a standalone device.

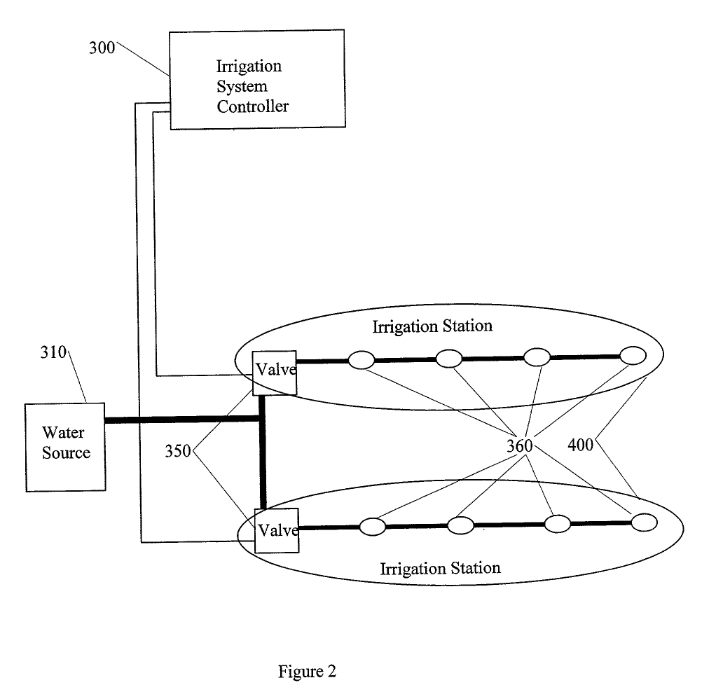

In FIG. 2 the irrigation system controller 300 may be either an automatic irrigation controller as illustrated in FIG. 1, a manual input controller, or a personal computer. Some irrigation systems do not use automatic irrigation controllers as illustrated in FIG. 1, for example, agricultural irrigation systems. Therefore, a manual input controller or a personal computer would likely control the agricultural irrigation system. The irrigation system controller 300 operates two irrigation stations 400. It will be understood that these stations 400 are indicative of any two or more irrigation stations, and are not to be interpreted as limiting the number or configuration of stations. It is contemplated that the irrigation stations may be part of an underground installed irrigation system, such as those used on residential sites, commercial sites, golf courses, public parks, and so forth. Additionally, the irrigation stations may be part of center pivot systems, wheel type systems, solid set systems, or any other irrigation system used in the irrigating of plants. Among other things, the irrigation controller 200 operates solenoids (not shown), which open the station valves 350 to allow irrigation water to flow from the water source 310 to be distributed to the various irrigation stations 400 and thereby irrigate the landscape through one or more (four are shown for each irrigation station but it may be any number) irrigation sprinkler heads 360.

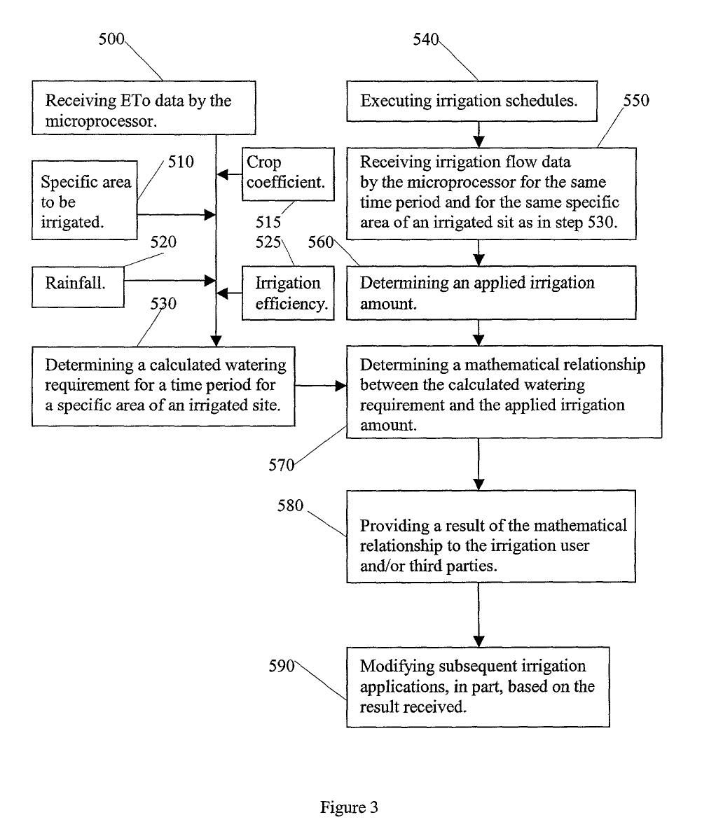

The microprocessor may receive the ETo data from a distal source, such as from a weather station, radio station or some other distal source via a telephone line, radio, pager, two-way pager, internet, cable, or any other suitable communication mechanism (FIG. 3, step 500). It is also contemplated, however, that the microprocessor may receive the ETo data or weather data from which the ETo data is determined from a local source, such as sensors at the irrigation site or other local sources. The ETo data, from which the calculated watering requirement is derived, may advantageously comprise current ETo data (i.e., within the last week, three days, or most preferably within the last 24 hours). The current ETo data may be potential ETo data that is calculated based on the following four weather factors; solar radiation, temperature, wind, and relative humidity. Alternatively, the current ETo data may be estimated ETo data (as for example that described in pending U.S. patent application Ser. No. PCT/US00/18705) that is based upon a regression model using one or more of the weather factors used in calculating the potential ETo, or historical ETo data (as for example that described in pending U.S. patent application Ser. No. PCT/US00/40685).

In step 530 the microprocessor determines the calculated watering requirement for a time period for a specific area of an irrigated site 510. The specific area may be the entire irrigated site or a portion of it, such as, a zone watered by a station. The specific area of an irrigated site is preferably stored in the memory but may be obtained from a distal source at the time the determination is performed.

It is contemplated that, in addition to ETo data 500 and a specific area to be irrigated 510, the calculated watering requirement determination 530 may be based on other information stored in the memory and or received by the microprocessor that would help in the determination of the best estimate of the water requirements for the plants grown at the irrigated site. Other information may include such factors as, a crop coefficient value 515, rainfall data 520 an irrigation efficiency value 525 and other meteorological, geographical, soil, etc. information.

Preferably, the time period that the calculated watering requirement is determined for is one day. However, it may be a time period as little as ten seconds or as much as a year or more. It is additionally contemplated that the calculated watering requirement may be a plurality of periods of time, for example, daily periods may be accumulated to arrive at a calculated watering requirement for a month time period, seasonal time period, and so forth.

In a preferred embodiment, the ETo data that is received in step 500 and used in determining the calculated watering requirement in step 530 (whether potential, estimated, or historical) is also used to derive irrigation schedules that are executed at the irrigated site 540. The irrigation flow is measured during the actual irrigation of the area of land that was used in the determining of the calculated watering requirement and for a time period equal to the time period used in the determining of the calculated watering requirement 550. The flow data is preferably obtained from a utility meter that was initially installed at the irrigation site. Alternatively, the flow data may be from a flow meter separate from the utility meter at the irrigation site. Preferably water pressure is also measured at the irrigated site. Variation in water pressure affects the flow rate of water and may help explain differences that may exist between the calculated watering requirement and the applied irrigation amount.

In a preferred embodiment the microprocessor (see FIG. 1, 220) receives data from the flow meter 292 and water pressure sensor 293 via a direct hardwire connection but may receive the data by any suitable wireless link, such as optical, radio, hydraulic or ultrasonic. It is further contemplated that the data from the flow meter 292 and pressure sensor 293 may be manually entered into the device in which the microprocessor is disposed. The data received by the microprocessor 220 can be any combination of raw and processed data. “Raw data” is defined herein to mean pulse or other data outputted by the meters and sensors and otherwise unprocessed except for formatting changes such as conversion from analog to digital, inclusion of appropriate signals to conform to parallel or serial transmission standards, and so forth. Raw data is preferably closely indicative of utility usage and sensor measurements, and may, for example, include digital, analog, pulse, or binary data taken directly from the flow meter 292 or pressure sensor 293. Processed data is data other than raw data and preferably is also closely indicative of utility usage and may include, for example, encrypted, daily, weekly, or monthly averages determined from the raw data.

Although flow data is the preferred method to use in determining the applied irrigation amount 560, it is contemplated that other data may be used in the determining of the applied irrigation amount. For example, a water collector could be used to determine the application rates of the irrigation system. The application rate could then be multiplied times the number of minutes the irrigation water was applied to arrive at the applied irrigation amount. Many other methods are contemplated that can achieve similar results.

In step 560, an applied irrigation amount is determined for a time period that is similar to the time period used in the determination of the calculated watering requirement. It is contemplated that the determination of water applied may advantageously be determined for a period less than the time period used for the determination of the calculated watering requirement. For example, if the water flow that occurs during the irrigating of a specific site is known to be an approximate amount for a specific time period, such as during each minute, then the flow of water for a minute can be determined. If the water flow is less than or more than set limits, an alarm may be sent to the irrigation user and/or a third party and the irrigation system checked for any anomalies. This might result in the early detection of an irrigation anomaly, which may provide savings to the irrigation user and/or prevent damage to the plants, for example, if no water was applied to an area due to a stuck valve or if flooding occurred due to a broken line.

In step 570, a mathematical relationship is determined between the calculated watering requirement and the applied irrigation amount for the irrigating of a specific area of an irrigated site during a time period. The mathematical relationship may be a ratio of the calculated watering requirement to the applied irrigation amount, the difference between the calculated watering requirement and the applied irrigation amount or any other suitable mathematical relationship between the calculated watering requirement and the applied irrigation amount.

In a preferred embodiment of the present invention the results from the determination of the mathematical relationship between the calculated watering requirement and the applied irrigation amount are provided to the irrigation user and/or third parties 580. The results may be provided as a ratio, a difference, a graph, actual values of the calculated watering requirement and the applied irrigation amount, or any other suitable form that aids the irrigation user and/or third party in the efficient management of the irrigation system.

The output device may display the results to the irrigation user and/or third parties. Displays can be any reasonable size, shape, composition, and so forth. Display 210 in FIG. 1 is a few inches on a side, and is an LED or liquid crystal type display. Other displays may be located away from the irrigation controller, such as in a personal computer. It is also contemplated that the results may be communicated to the irrigation user and/or third parties through means other than liquid crystal type displays, such as through printed material, audible messages, such as via a telephone system or any other suitable means that would communicate the results to irrigation users and/or third parties.

It is contemplated that the irrigation user is a human being that uses the irrigation system locally, or is responsible for local monitoring or controlling of the irrigation system at the property. For a residential property, the irrigation user is usually the homeowner or a renter. In a commercial or agricultural setting, the irrigation user is usually an employee of the property owner, manager, leaser, or renter. Formal title of irrigation users is not important, as the irrigation user at a commercial property may be referred to as an engineer, building supervisor, etc.

Third party is a legal person other than the irrigation user that has an interest in the irrigating done by the irrigation user. A third party need not be a physical person, and may well be a water district or other government agency, or an individual or company involved in the care or management of the property, but not locally situated at the property.

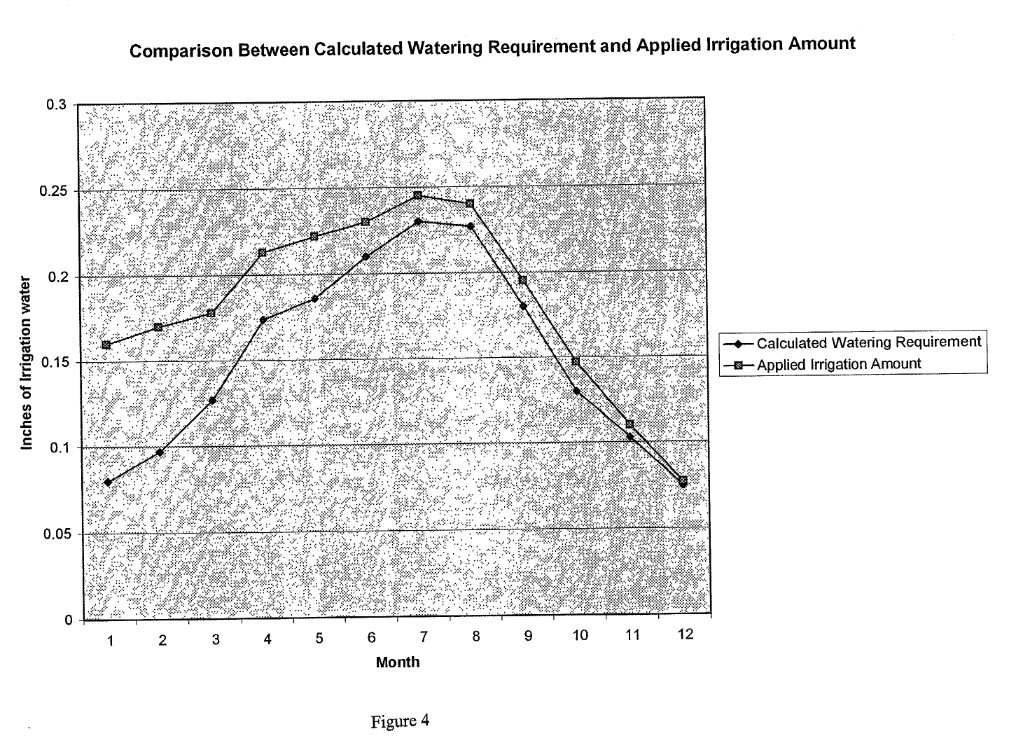

The irrigation user preferably uses the results to modify subsequent irrigation schedules to improve the efficiency of the irrigation system 590. For example, if the calculated watering requirement is more than the applied irrigation amount then subsequent irrigation times may be reduced which will reduce the potential waste of water (see graph of FIG. 4). It is contemplated that as the irrigation user improves the result of the mathematical relationship the number of irrigation user changes over the year will reduce in frequency. If dry spots occur with a reduction in the irrigation amount but the applied irrigation amount still exceeds the calculated watering requirement, the irrigation system should be checked for distribution uniformity since some areas of the landscape may be receiving excessive amounts of water while other areas are turning brown due to lack of water.

Using the relationship of a calculated watering requirement to an applied irrigation amount may also be a tool that water districts, during a time when there is a water shortage, could use to motivate irrigation users to practice efficient irrigating of their landscapes based on ETo data.

The present inventive subject matter can also be viewed as a method of generating a mathematical relationship between a calculated watering requirement and an applied irrigation amount, comprising: determining a calculated watering requirement for a time period for an irrigated site; determining an applied irrigation amount for a time period for an irrigated site; determining a mathematical relationship between the calculated watering requirement and the applied irrigation amount; and providing a result of the mathematical relationship to at least one of an irrigation user and a third party.

Thus, specific embodiments and applications of methods and apparatus of the present invention have been disclosed. It should be apparent, however, to those skilled in the art that many more modifications besides those described are possible without departing from the inventive concepts herein. The inventive subject matter, therefore, is not to be restricted except in the spirit of the appended claim.

What is claimed is:

1. An irrigation management system comprising:
a microprocessor programmed to (a) determine a calculated watering requirement and an applied irrigation amount for a time period for an area of an irrigated site and (b) determine a mathematical relationship between the calculated watering requirement and the applied irrigation amount; and
an output device that provides a result of the mathematical relationship to at least one of an irrigation user and a third party.

2. The irrigation management system of claim 1, wherein the microprocessor is disposed in an irrigation controller.

3. The irrigation management system of claim 1, wherein the microprocessor is disposed in a personal computer.

4. The irrigation management system of claim 1, wherein the calculated watering requirement is at least partly derived from ETo data.

5. The irrigation management system of claim 4, wherein the ETo data comprises potential ETo data.

6. The irrigation management system of claim 4, wherein the ETo data comprises estimated ETo data.

7. The irrigation management system of claim 4, wherein the ETo data comprises historical ETo data.

8. The irrigation management system of claim 4, wherein the ETo data is received from a device local to the irrigation site.

9. The irrigation management system of claim 4, wherein the ETo data is received from a device distal to the irrigation site.

10. The irrigation management system of claim 1, wherein the calculated watering requirement is at least partly derived from a crop coefficient value.

11. The irrigation management system, wherein the calculated watering requirement is at least partly derived from an irrigation efficiency value.

12. The irrigation management system of claim 1, wherein the applied irrigation amount is derived from data obtained from an irrigation water collector.

13. The irrigation management system of claim 1, wherein the applied irrigation amount is derived from flow data obtained from a flow meter.

14. The irrigation management system of claim 13, wherein the flow data is from a utility meter that was initially installed at the irrigation site.

15. The irrigation management system of claim 13, wherein the flow data is from a flow meter separate from the utility meter installed at the irrigation site.

16. The irrigation management system of claim 13, wherein the flow data comprises raw data.

17. The irrigation management system of claim 1, wherein the time period is at least 10 seconds.

18. The irrigation management system of claim 1, wherein the irrigated site is a residential site.

19. The irrigation management system of claim 1, wherein the irrigated site is an agricultural site.

20. The irrigation management system of claim 1, wherein the output device is a display screen.

21. The irrigation management system of claim 1, wherein the output device is printed material.

22. The irrigation management system of claim 1, wherein the result comprises a ratio of the calculated watering requirement to the applied irrigation amount.

23. The irrigation management system of claim 1, wherein the result comprises a difference between the calculated watering requirement and the applied irrigation amount.

24. The irrigation management system of claim 11, further comprising measuring water pressure data that is communicated to the irrigation user by the output device.

25. A method of generating a mathematical relationship between a calculated watering requirement and an applied irrigation amount for use in an irrigation management system, comprising:
determining a calculated watering requirement for a time period for an irrigated site;
determining an applied irrigation amount for a time period for an irrigated site;
determining a mathematical relationship between the calculated watering requirement and the applied irrigation amount; and
providing a result of the mathematical relationship to at least one of an irrigation user and a third party.
